(19) United States
(12) Patent Application Publication
(10) Pub. No.: US 2005/0077268 A1
(43) Pub. Date: Apr. 14, 2005

(54) Welding electrode comprising an ultrasound probe

(76) Inventors: Goran Vogt, Burgwedel (DE); Olaf Moller, Wunstorf (DE)

Correspondence Address: WILLIAM COLLARD;COLLARD & ROE, P.C., 1077 NORTHERN BOULEVARD, ROSLYN, NY, 11576, US

(21) Appl. No.: 10/503,966

(22) PCT Filed: Feb. 25, 2003
(86) PCT No.: PCT/DE03/00596

(30) Foreign Application Priority Data
Feb. 25, 2002 (DE) 10207801.7

(51) Int. Cl. H05B 3/00

(52) U.S. Cl. 219/55; 219/50

(57) ABSTRACT

The invention relates to the welding electrode of a resistance welder, comprising a shaft (10) with a welding cap (10) and cooling water pipes (20) disposed inside the shaft (10). A probe is acoustically coupled with the ultrasound probe (14) for transmitting and/or receiving ultrasound signals and is linked with an evaluation device outside the welding electrode via signal lines (24). The probe (14) is disposed inside or in the vicinity of the welding cap (12) and coupled therewith via an elastically deformable pad (16).

The invention relates to a welding electrode according to the preamble of claim 1.

Probes for transmitting and/or receiving ultrasound signals in welding electrodes as a component of ultrasound testing systems are used to monitor spot welds during the welding process. Two probes built into the welding head of welding tongs yield ultrasound signal images in sound transmission and/or in pulse echo operation. A Hall sensor or a welding current induction sensor provide an evaluation device with information on the type of weld and the required time for beginning welding.

Both pulse/echo signals and sound transmission signals are recorded during the entire welding. The ultrasound information is evaluated directly in a computer of the evaluation device. The result on the quality of the welding spot, using the grades “good”, “medium/critical”, “poor”, and trend information relating to the weld spatter is passed on to a communication server for further processing.

In order to determine the quality of the welding spot as precisely as possible, clear, interference-free and superposition-free ultrasound signals are essential during sound transmission and in pulse/echo operation. Influences from the immediate surroundings and also conditions in the electrode shaft should have no influence here. Furthermore, the use of probes should not result in an increase in the external spatial dimensions of the shaft since the useability of the welding tongs would thus be limited for complex-shaped components.

The object of the invention is to improve the ultrasound coupling between the probe and the welding cap with a small overall size and to reduced perturbing influences in a welding electrode of the type described initially.

This object is solved with a welding electrode according to the preamble of claim 1 by the features of this claim.

Further developments and advantageous embodiments are obtained from the dependent claims.

The probes used are placed as close as possible to the test object, the welding spot, so that the distance between the two probes has a minimum. In this case there is room for the two probes in the electrode shafts of the welding tongs. They form the extension of the cooling water pipes which are used to guide the cooling water to the welding cap. In order to avoid overheating of the heads, these are continuously bathed with the cap cooling water. Not only the water used for cooling but also a special pad affixed to the probe is used for coupling the heads to the caps.

Like the complete probe, the pad is also bathed with cooling water. The contact pressure of the pad on the cap base required for the coupling is accomplished via the elastic deformation of the pad when the cap is put on and/or via a spring element integrated on the probe holder. In the unmounted state the pad has a longer length than the distance between the sound outlet surface on the probe and the cap base in the mounted state. Slight changes in the cap base caused by the manufacture are hereby likewise compensated. The displacement path of the cap on the cone located on the shaft is constrained by said spring element. The actual probe is held by the probe holder in the hole area of the cone. The probe housing rests against no point of the hole wall in said region so that any tapering of the hole diameter as a result of the cap pressure on the cone cannot cause this to jam.

The signal lead linking the probe to the evaluation device in this case runs through the cooling water pipes as far as the electrode shaft holder or can be laid further through the cooling water channel of the entire tong arm.

Optionally there is also the possibility of withdrawing the lead from the electrode shaft shortly after the probe housing by means of a plug connection.

As a result of the simple structure, it is possible to miniaturise the probe including the pad such that the external dimensions of the electrode shaft and the welding cap can be retained.

The following advantages are achieved by the structure according to the invention:

Perpendicular, specific introduction of the ultrasound into the welding cap is achieved wherein the insonification point can be varied via the position of the head in the shaft. It is thus also possible to introduce the sound decentralised into the welding cap which brings with it advantages when using non-rotationally symmetrical welding caps.

Moreover, as a result of the elastically deformable pad, a uniform coupling of the probe to the cap base is achieved. As a result of the pad, the negative influence of the flowing cooling water on the ultrasound signal in the water coupling conventionally used is dispensed with.

The external dimensions and the arrangement of the electrode shafts can be retained because of the miniaturisation of the probe. Thus, integration into the shaft can easily be achieved.

Any impairment of the cooling water flow rate can be compensated if desired by means of a compensating hole.

Furthermore, the head can easily be adapted to the cooling circuit. The structure is created such that if the length of the cooling water pipe is matched, the probe is connected to the cooling water supply after inserting the head into the shaft. Alternatively, the head could be manufactured with an adapted pipe. The entire unit could then be screwed in the head of the electrode pipe as usual using the thread located on the cooling water pipe.

There is also a higher flexibility for installation in “exotically” shaped shafts. As a result of the small structure, all shafts can generally be fitted with the heads. This also includes short curved shafts.

Finally better cable guidance is achieved from the probe up to the interface for connecting the welding tongs to the evaluation device. As a result of the probe being already located in the cooling circuit, it is possible to lay the fine probe cable through the entire cooling water supply pipe. There is no risk of mechanical damage to the cable in the critical welding area.

The invention is explained subsequently with reference to the drawings. In the figures:

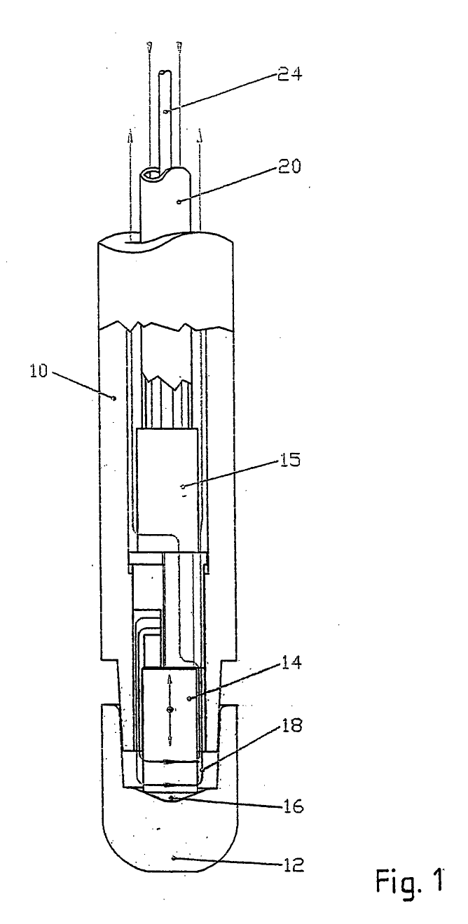

FIG. 1 shows a schematic cross-section through a welding electrode as a component of a welding tong with two opposing welding electrodes and

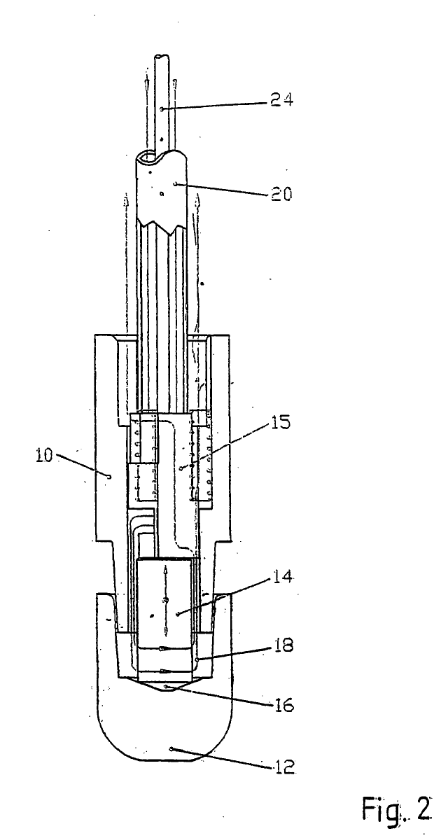

FIG. 2 is a diagram similar to FIG. 1 but with an additional spring element in the probe holder.

FIG. 1 shows a schematic cross-section through a welding electrode as a component of a welding tong with two opposing welding electrodes between which are located two sheets to be joined.

The welding electrode comprises a shaft 10 and a welding cap 12 which comes in electrically conducting contact with one of two sheets to be joined.

The shaft 10 and the welding cap 12 form a hollow interior in which cooling water pipes with cooling water tubes 20 are arranged inside the welding electrode to produce a cooling water circuit. Located in the area of the welding cap 12 and adjacent to the cap base are a probe holder 15 and a probe 14 to transmit and/or receive ultrasound signals which are coupled into the welding cap 12. The coupling-in is achieved by an elastically deformable pad 16.

Both the probe 14 and also the elastically deformable pad 16 lie in the cooling water circuit and the cooling water stream 18 flows around them as shown in the drawing.

The signal leads 24, which connects the probe 14 to an evaluation device not shown here, pass through the cooling water pipes.

It is also possible to accommodate these directly in the cooling-water-guiding cooling water tubes 20 or in a central channel 24.

In the design according to FIG. 2 a spring element is additionally integrated in the probe holder 15 which centres the probe 14 at the top and presses against the coupling pad 16.

1. A welding electrode of a resistance welder, comprising a shaft (10) with a welding cap (12) and cooling water pipes (20) arranged inside the shaft (10) and a probe (14) acoustically coupled to the welding cap (12) for transmitting and/or receiving ultrasound signals, wherein the probe (14) is linked to an evaluation device outside the welding electrode via a signal line (24), wherein the probe (14) is arranged inside or in the vicinity of the welding cap (12), is held and centred by a probe holder (15) and the probe (14) is coupled to the welding cap (12) via an elastically deformable coupling pad (16) and can be pressed against the welding cap (12) by a spring element in the probe holder (15).

2. The welding electrode according to claim 1, wherein the probe (14) is arranged substantially axially in the shaft (10), wherein the insonification point in the welding cap (12) can be adjusted via the position of the probe (14) in the shaft (10).

3. The welding electrode according to claim 1, wherein the external dimensions of the probe (14) and the coupling pad (16) are smaller than the internal dimensions of a cavity in the shaft (10) and the probe (14) and the pad (16) are arranged in the cooling water circuit.

4. The welding electrode according to claim 1, wherein the signal lines (22) connecting the probe (14) to the evaluation device are guided through cooling water pipes (20).
